(19) United States
(12) Patent Application Publication
(10) Pub. No.: US 2019/0159031 A1
(43) Pub. Date: May 23, 2019

(54) Network Access Control

(71) Applicant: Checkit Limited, CAMBRIDGE (GB)

(72) Inventor: Simon John Haswell, Bedfordshire (GB)

(21) Appl. No.: 16/096,546

(22) PCT Filed: Apr. 19, 2017
(86) PCT No.: PCT/GB2017/051087

§ 371 Date: Oct. 25, 2018

(30) Foreign Application Priority Data
Apr. 26, 2016 (GB) 1607251.4

(51) Int. Cl. H04W 12/08; H04W 12/06; H04W 12/04; H04W 12/00; H04L 29/06; H04L 9/06

(52) U.S. Cl. CPC H04W 12/08; H04W 12/0608; H04W 12/04; H04W 12/001; H04W 88/02; H04L 63/101; H04L 63/0876; H04L 9/0643; H04W 12/00512

(57) ABSTRACT

A device for permitting a remote device access to a secure network, the device comprising: a wireless transceiver; a memory storing a network key associated with the secure network; and a control module, wherein the control module is configured to: form a first network and form the secure network; allow the remote device to join the first network upon detection of the remote device having a network key associated with the first network, wherein the network key associated with the first network is also stored in said memory; and once the remote device has joined the first network, the control module is configured to: receive, via said wireless transceiver, a unique identifier of the remote device transmitted from the remote device; determine whether the remote device is authorised to access the secure network based on said unique identifier; and transmit, via said wireless transceiver, the network key associated with the secure network in encrypted form to the remote device to permit the remote device access to the secure network, in dependence on said determination.

### FIELD OF THE INVENTION

The invention relates to controlling access to a network. In particular the invention relates to controlling access to a Zigbee network.

### BACKGROUND TO THE INVENTION

Zigbee is a standardised wireless network protocol. The IEEE 802.15.4 defines the specifications for physical layer and media access control layer (MAC), and the ZigBee alliance defines the upper-layer specifications comprising the standards at the network layer and the application layer.

A device referred to as a network coordinator (otherwise referred to herein as a hub device) forms a Zigbee network. A Zigbee network is typically referred to as a personal area network (PAN). Nodes are able to join the Zigbee network by having the network coordinator open the network up to new devices. This involves transmission of a network key (that enables encrypted communication) in unencrypted form from the network coordinator to the joining node device.

### SUMMARY OF THE INVENTION

The inventor has identified that this transmission results in a short timeframe of exploitability in which the unencrypted network key could be obtained by undesired nodes who could then join the network. Thus this represents a security risk albeit in a limited window of time. The inventor has further identified that pre-programming a node device with a network key (e.g. at the time of manufacture) compromises security of the network key as it will be vulnerable to being accessed via unauthorised persons, and introduces complexity into the production and logistical problems for system operators to track devices, networks and keys.

According to one aspect of the present invention there is provided a device for permitting a remote device access to a secure network, the device comprising: a wireless transceiver; a memory storing a network key associated with the secure network; and a control module, wherein the control module is configured to: form a first network and form the secure network; allow the remote device to join the first network upon detection of the remote device having a network key associated with the first network, wherein the network key associated with the first network is also stored in said memory; and once the remote device has joined the first network, the control module is configured to: receive, via said wireless transceiver, a unique identifier of the remote device transmitted from the remote device; determine whether the remote device is authorised to access the secure network based on said unique identifier; and transmit, via said wireless transceiver, the network key associated with the secure network in encrypted form to the remote device, to permit the remote device access to the secure network in dependence on said determination.

The control module may be configured to: transmit, via said wireless transceiver, the unique identifier to an authentication server; receive, via said wireless transceiver, an authentication response from the authentication server; and determine whether the remote device is authorised to access the secure network based on said authentication response.

The memory may comprise a whitelist which is arranged to store unique identifiers of remote devices successfully authenticated by an authentication server, and the control module may be configured to query the whitelist and determine that said remote device is authorised to access the secure network based on the unique identifier being present in the whitelist.

The control module may be further configured, in response to determining that the unique identifier is not present in the whitelist, to transmit, via said wireless transceiver, the unique identifier to the authentication server; receive, via said wireless transceiver, an authentication response from the authentication server; and determine whether the remote device is authorised to access the secure network based on said authentication response.

The memory may comprise a blacklist which is arranged to store unique identifiers of remote devices that have failed authentication by the authentication server, and the control module may be further configured, in response to determining that the unique identifier is not present in the whitelist, to query the blacklist and determine that said remote device is not authorised to access the secure network based on the unique identifier being present in the blacklist.

The control module may be further configured, in response to determining that the unique identifier is not present in the blacklist, to transmit, via said wireless transceiver, the unique identifier to the authentication server; receive, via said wireless transceiver, an authentication response from the authentication server; and determine whether the remote device is authorised to access the secure network based on said authentication response.

The control module may be configured, in response to determining that the remote device is authorised to access the secure network, to add the unique identifier to the whitelist.

The control module may be, in response to determining that the remote device is not authorised to access the secure network, to add the unique identifier to the blacklist.

The control module may be, in response to determining that the remote device is authorised to access the secure network, to transmit the network key associated with the secure network in encrypted form, to the remote device.

The control module may be further configured, in response to determining that the remote device is authorised to access the secure network, to transmit at least one parameter of the secure network to the remote device.

The at least one parameter may comprise one or any combination of: an Extended Personal Area Network Identifier associated with the secure network, a Personal Area Network Identifier associated with the secure network, a 64-bit Extended Unique Identifier associated with the secure network, and an operating frequency of the secure network.

The memory may store an encryption key for encrypting the network key associated with the secure network, and the control module may be configured to use said encryption key to encrypt the network key associated with the secure network.

The memory may store a further encryption key and the control module may be configured to generate a message comprising at least the encrypted network key associated with the secure network, and transmit the message in encrypted form to the remote device using the further encryption key.

The control module may be configured, in response to determining that the remote device is not authorised to access the secure network, to transmit a reject message to the remote device to cause the remote device to leave the first network.

The unique identifier may comprise a serial number associated with the remote device or a medium access control address associated with the remote device. In other embodiments, the unique identifier comprises a hash value derived from a hash function computed at the remote device.

The control module may be configured to receive via the transceiver, a request to join the first network transmitted from the remote device, and in response, transmit via the transceiver the network key associated with the first network in unencrypted form to the remote device.

The control module may be configured to form the first network as a secure network, whereby only remote devices pre-programmed with the network key associated with the first network are permitted to join the first network.

The control module may be configured to form the first network using a preconfigured Extended Personal Area Network Identifier or an Extended Personal Area Network Identifier selected from a preconfigured range of values for the Extended Personal Area Network Identifier.

The control module may be configured to receive, via the transceiver, a request to join the secure network that is transmitted by the remote device over the first network, and allow the remote device to join the secure network upon detection of the remote device having the network key associated with the secure network.

The first network and the secure network may be Zigbee networks.

According to another aspect of the present invention there is provided a method for permitting a remote device access to a secure network, the method comprising: forming a first network and forming the secure network; allowing the remote device to join the first network upon detection of the remote device having a network key associated with the first network; and once the remote device has joined the first network, the method further comprising: receiving a unique identifier of the remote device transmitted from the remote device; determining whether the remote device is authorised to access the secure network based on said unique identifier; and transmitting, via said wireless transceiver, the network key associated with the secure network in encrypted form to the remote device, to permit the remote device access to the secure network in dependence on said determination.

According to one aspect of the present invention there is provided a computer program product for permitting a remote device access to a secure network, the computer program product comprising code embodied on a computer-readable medium and being configured so as when executed on a processor to: form a first network and form the secure network; allow the remote device to join the first network upon detection of the remote device having a network key associated with the first network; and once the remote device has joined the first network, the code being further configured so as when executed on the processor to: receive a unique identifier of the remote device transmitted from the remote device; determine whether the remote device is authorised to access the secure network based on said unique identifier; and transmit the network key associated with the secure network in encrypted form to the remote device, to permit the remote device access to the secure network in dependence on said determination.

In yet another aspect of the present invention there is provided a communication system comprising: the device described herein for permitting a remote device access to a secure network, a cloud-based authentication server connected to the device; and at least one remote device.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 illustrates a schematic block diagram of a communication system;

FIG. 2 illustrates a schematic block diagram of a network coordinator device of the communication system;

FIGS. 3a to 3c illustrate sequence diagrams showing data transmitted between devices of the communication system; and

FIG. 4 illustrates an architecture comprising the communication system.

### DETAILED DESCRIPTION

Broadly speaking, the present invention seeks to overcome security problems associated with Zigbee by using a hub device with a cloud connection which hosts two Zigbee networks, an installation (guest) network and a closed (i.e. private) network, i.e. the hub device is a network coordinator. The network coordinator allows a remote device to join the installation network so that authentication can be carried out. The network coordinator only permits the remote device access to the closed network if the remote device is successfully authenticated. This advantageously isolates the closed network from any non-authorised devices.

Embodiments will now be described by way of example only.

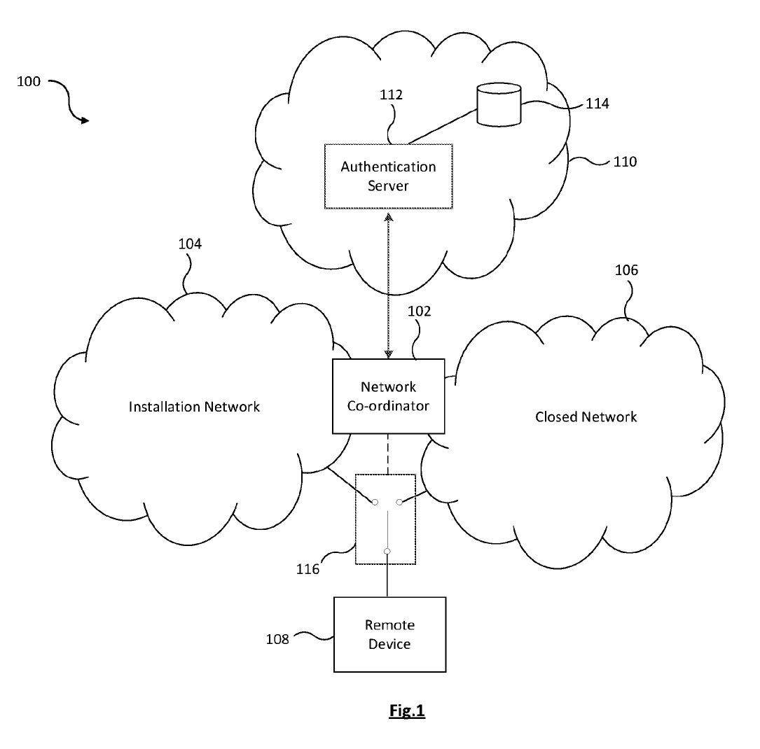

Reference is first made to FIG. 1 which illustrates a communication system 100. The communication system 100 comprises a network coordinator device 102 which supports two concurrent Zigbee networks.

The network coordinator 102 forms the installation network 104 by scanning the available radio frequency (RF) channels available and decides which one to use (this process involves performing an “energy scan” and an “active scan” which is well known to persons skilled in the art and is therefore not described in detail herein). The network coordinator 102 forms the installation network 104 on the selected channel using a preconfigured 64-bit PAN ID (also known as an Extended Personal Area Network ID).

In particular, the network coordinator 102 may form the installation network 104 using a pre-defined mask for the 64-bit PAN ID (selecting a 64-bit PAN ID from a pre-defined range of values for the 64-bit PAN ID).

A remote device 108 is pre-programmed (e.g. in firmware) to join the closest network matching the preconfigured 64-bit PAN ID or pre-defined mask.

The remote device 108 requires a network key (e.g. a 128-bit key) associated with the installation network 104 in order to join the installation network 104. The network key associated with the installation network 104 is shared between every device on the installation network 104 and is used to cypher all the data sent within the installation network 104. The remote device 108 may obtain the network key associated with the installation network 104 in various ways as will be described in more detail below.

Whilst FIG. 1 shows a single remote device for simplicity, it will be appreciated that multiple remote devices may join the installation network 104 so that authentication can be performed for each remote device in accordance with embodiments described herein.

The network coordinator 102 also has a connection to the cloud 110. The term ‘cloud’ used herein refers to a network of remote servers hosted on the Internet and used to store, manage and process data in place of local servers or personal computers. The cloud comprises an authentication server 112 and a data store 114. Whilst a single authentication server 112 is shown in FIG. 1 for simplicity, it will be appreciated that the functionality of the authentication server 112 described herein may be implemented by a plurality of servers. Similarly, whilst a single data store 114 is shown in FIG. 1 for simplicity, it will be appreciated that multiple data stores may be present. The authentication server 112 is configured to check credentials of a remote device 108 it receives from the network coordinator 102 against data stored in the data store 114 in order to determine whether to authenticate the remote device 108.

In a similar manner to the formation of the installation network 104, the network coordinator 102 forms the closed network 106 by scanning the available RF channels available and decides which one to use. The network coordinator 102 forms the closed network 106 on the selected channel using a random 64-bit PAN ID. The network 106 is referred to as being “closed” in that any devices wishing to join the closed network 106 require a pre-configured link key (e.g. a 128-bit key). The pre-configured link key could be a single link key for all remote devices, a key derived from a bit of shared data (such as the joining node's EUI64 Address), or a unique, randomly generated key for each remote device.

The network coordinator 102 is configured to pass the network key associated with the closed network 106 to a remote device 108 in encrypted form in dependence on the remote device 108 being successfully authenticated. In particular, the network coordinator 102 uses the pre-configured link key to send the network key associated with the closed network 106 cyphered to the remote device 108, and the joining remote device 108 requires the pre-configured link key in order to decrypt the network key associated with the closed network 106.

Thus it can be seen from the above that the network coordinator 102 sets up both the installation network 104 and the closed network 106, and following this setup process, the network coordinator 102 is connected to both the installation network 104 and the closed network 106.

The network coordinator 102 only permits the remote device 108 access to the closed network 106 if the remote device 108 is successfully authenticated by the authentication server 112 (described in more detail below). The switching between the remote device 108 being initially connected to the installation network 104 and then being permitted access to the closed network 106 by the network coordinator 102 (in dependence on the result of the authentication check performed by the authentication server 112) is shown conceptually in FIG. 1 by the switch 116. It will be appreciated that a physical switch is not present in the communication system 100.

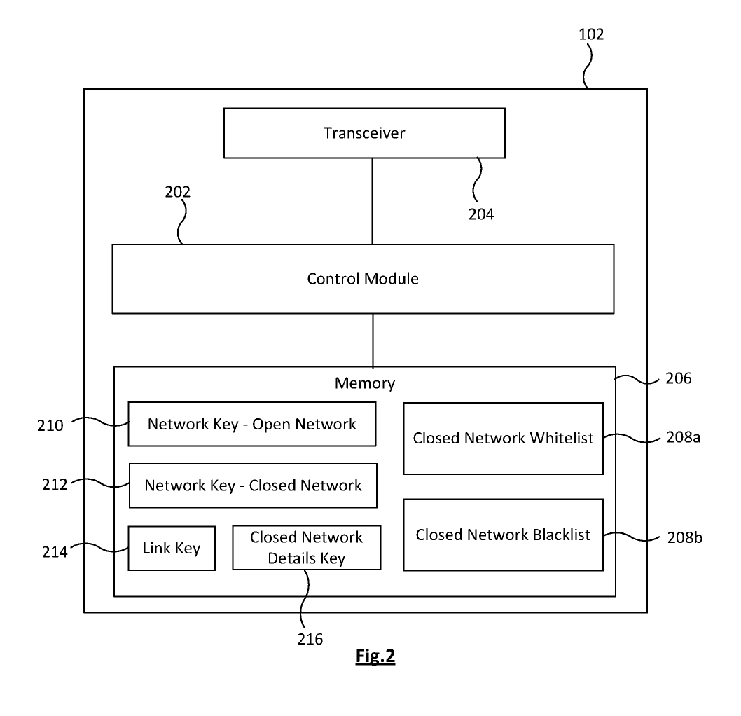

FIG. 2 illustrates a schematic block diagram of the network coordinator 102. As shown in FIG. 2, the network coordinator 102 comprises a control module 202 coupled to a transceiver 204 and a memory 206. It will be appreciated that network coordinator 102 may comprise other components that have not been shown in FIG. 2 for clarity purposes.

The control module 202 is configured to form the installation network 104 and the closed network 106. The control module 202 is also configured to control the grant of access to the closed network 106 to a remote device 108 by way of transmission and reception of data to the remote device 108 and the authentication server 112.

The control module 202 is arranged to transmit data to the remote device 108 and to the authentication server 112 via the transceiver 204. Similarly, the control module 202 is arranged to receive data transmitted from the remote device 108 and transmitted from the authentication server 112 via the transceiver 204.

The functionality of the control module 202 referred to herein may be implemented in code (software) stored on a memory (e.g. memory 206) comprising one or more storage media, and arranged for execution on a processor (not shown in FIG. 2) comprising one or more processing units. The code is configured so as when fetched from the memory and executed on the processor to perform operations in line with embodiments discussed herein. Alternatively it is not excluded that some or all of the functionality of the control module 202 is implemented in dedicated hardware circuitry, or configurable hardware circuitry like a field-programmable gate array (FPGA).

The network coordinator 102 stores Zigbee network keys in memory 206.

In particular, a network key 210 associated with the installation network 104 is stored in memory 206. The control module 202 uses the network key 210 to encrypt all network messages that are transmitted to devices on the installation network 104 and to decrypt all network messages that are received from devices on the installation network 104.

A remote device 108 requires the network key 210 in order to join and communicate with devices on the installation network 104 (e.g. the network coordinator 102). The network coordinator 102 may control the installation network 104 to be temporarily “open” when a remote device 108 is joining such that the network key is passed in the clear (unencrypted) to the remote device 108. That is, the control module 202 is configured to receive, via the transceiver 204, a request to join the installation network 104 transmitted from the remote device 108, and in response, transmit via the transceiver 204 the network key 210 associated with the installation network 104 in unencrypted form to the remote device 108.

Alternatively, the installation network 104 is “closed” in that the network key 210 is a shared secret pre-programmed into the remote device at manufacture (i.e. the network key 210 is stored in non-volatile memory in the remote device 108), and only devices being pre-programmed with the network key 210 may join the installation network 104.

A network key 212 associated with the closed network is also stored in memory 206. The control module 202 uses the network key 212 to encrypt all network messages that are transmitted to devices on the closed network 106 and to decrypt all network messages that are received from devices on the closed network 106. The network coordinator 102 is configured to pass the network key 212 to a remote device if it passes authentication.

The network coordinator 102 also stores one or more encryption keys in memory 206.

As discussed above, the network coordinator 102 is configured to pass the network key 212 associated with the closed network 106 to a remote device 108 in encrypted form in dependence on the remote device 108 being successfully authenticated. The memory 206 stores a pre-configured link key 214 which is used by the network coordinator 102 to send the network key 212 associated with the closed network 106 securely to the remote device 108.

A shown in FIG. 2, the memory 206 may also store a further encryption key—a “closed network details” key 216. This will be described in more detail below.

The memory 206 may store a closed network whitelist 208a which is used to store device credentials of remote devices which have been successfully authenticated by the authentication server 112. The memory 206 may also store a closed network blacklist 208b which is used to store device credentials of remote devices which have failed the authentication performed by the authentication server 112.

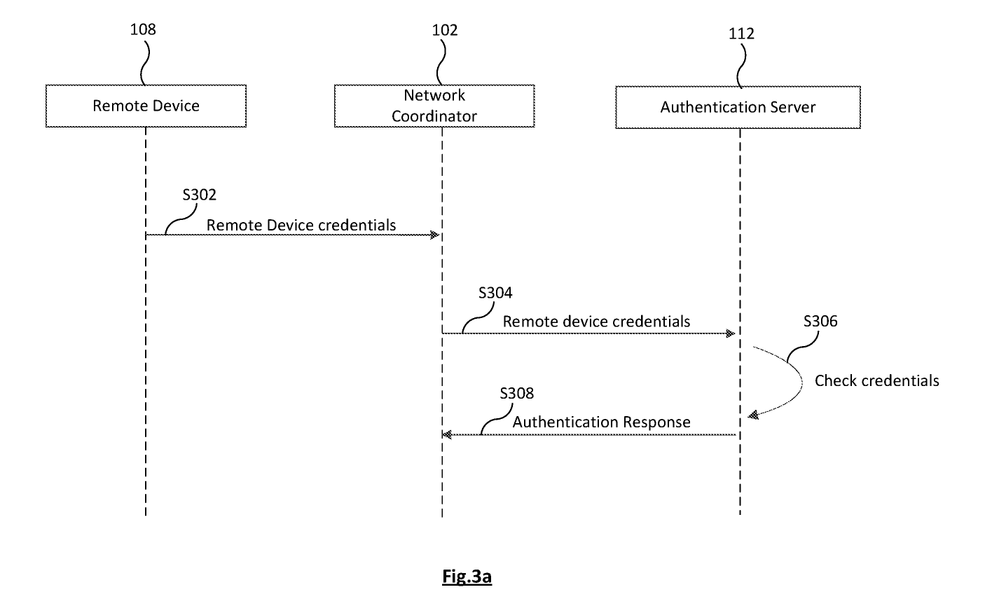

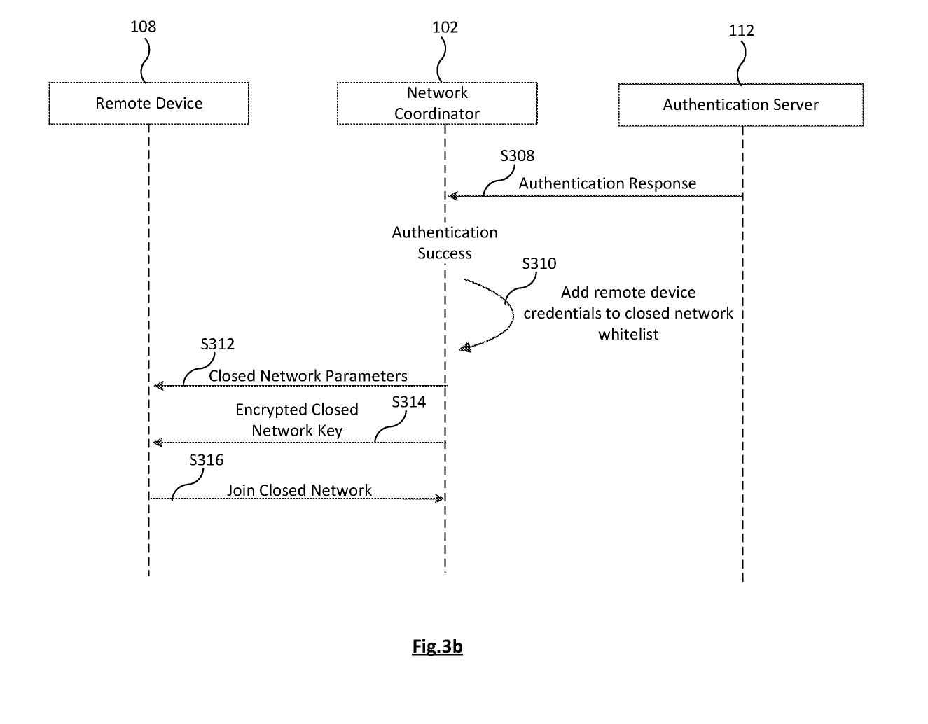

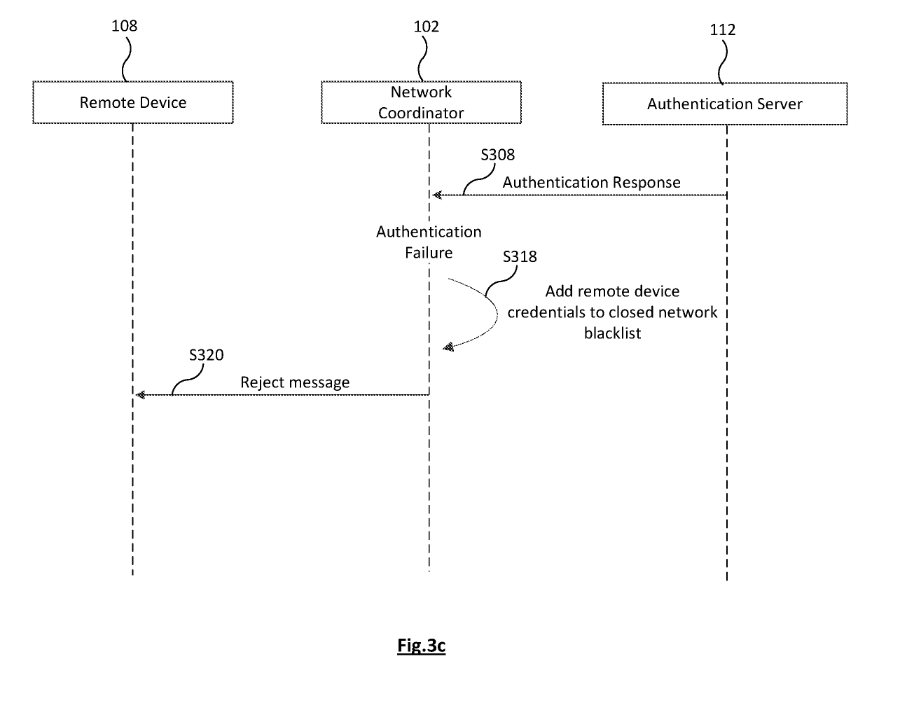

The operation of the network coordinator 102 in controlling the access to the closed network 106 given to a remote device 108 will now be described with reference to FIGS. 3a-3c.

FIG. 3a illustrates a first sequence diagram illustrating how the network coordinator 102 determines whether or not to permit a remote device 108 access to the closed network 106 once the remote device 108 has joined the installation network 104.

Each remote device 108 requires a unique identifier so that it can be identified by the authentication server 112. This unique identifier needs to be stored permanently on the remote device (e.g. in non-volatile memory on the remote device 108).

As shown in FIG. 3a, at step S302 a remote device 108 supplies credentials of the device (i.e. the unique identifier stored in the device) to the network coordinator 102.

The unique identifier of may take various forms. For example, the unique identifier may be the serial number of the remote device 108 assigned to the remote device at manufacture, or an 8-byte MAC (medium access control) address in the EUI64 format, or any other unique identifier associated with the remote device 108.

For enhanced security, the unique identifier may be hash value derived from computing a hash function on a set of unique identifiers (which may include for example a MAC address, serial number, date and/or time of manufacture, etc.) associated with remote device 108 which are stored in memory of the remote device 108. For example the unique identifier may be hash value derived from computing a hash function on the serial number of the remote device 108, the date of manufacture of the remote device 108 and a secret key (shared secret). It will be appreciated that a hash value would be more difficult than, for example a serial number for an unauthorised person to forge.

The control module 202 of the network coordinator 102 receives the unique identifier of the remote device 108 via the transceiver 204.

At step S304, the control module 202 transmits the received unique identifier of the remote device 108 to the authentication server 112 via the transceiver 204 for verification.

The data store 114 stores unique identifiers of all remote devices that are authorised to access the closed network 106. This information is pre-stored in the data store 114 by the entity providing the network coordinator 102 and the remote devices 108. It will be appreciated from the above that the unique identifiers associated with authorised remote devices that are stored in the data store 114 include at least the unique identifiers that are stored in the devices themselves so that verification can take place.

At step S306, the authentication server 112 queries the data store to determine whether the unique identifier it received at step S304 is present in the data store 114. Following this check, the authentication server 112 transmits an authentication response to the network coordinator 102 at step S308.

The authentication response may for example indicate whether the authentication was successful (the unique identifier it received at step S304 is present in the data store 114) or unsuccessful (the unique identifier it received at step S304 is not present in the data store 114).

FIG. 3b illustrates a second sequence diagram illustrating steps performed by the network coordinator 102 in the scenario of a successful authentication of the remote device 108.

The control module 202 of the network coordinator 102 receives, via the transceiver 204, the authentication response (indicating successful authentication of the remote device 108) transmitted by the authentication server 112 at step S308.

In embodiments whereby the memory 206 stores the closed network whitelist 208a referred to above, at step S310 the control module 202 is configured to add the unique identifier of the remote device 108 received at step S304 to the closed network whitelist 208a (so that authentication does not have to be carried out following re-join attempts—described in more detail below).

Once authenticated the remote device 108 needs the network key 212 associated with the closed network 106 so that the remote device 108 can join and communicate with devices on the closed network 106. To assist the remote device 108 in identifying the correct network before it attempts the join process, it is desirable (but not essential) that one or more parameters of the closed network 106 (e.g. the 64-bit PAN ID, 16-bit PAN ID, Extended Unique Identifier (EUI64) and operating frequency of the closed network 106) are transmitted to the remote device 108.

As shown in FIG. 3b, the control module 202 is configured to transmit parameters of the closed network 106 (at step S312) and the network key 212 in encrypted form (at step S314) to the remote device 108 via the transceiver 204.

In response to receiving, via the transceiver 204, a join request transmitted from the remote device 108 over the installation network 104 (requesting access to the secure network 106) at step S316, the control module 202 is configured to allow the remote device 108 to join the closed network 106 upon detection of the remote device 108 having the network key 212 associated with the closed network 106.

Whilst FIG. 3b shows separate transmissions at steps S312 and S314, it will be appreciated that the parameters of the closed network 106 and the encrypted network key 212 may be sent from the network coordinator 102 in a single message transmission.

In one embodiment, the authentication response merely indicates whether the authentication was successful or unsuccessful, and the control module 202 generates the message(s) to supply the parameters of the closed network 106 and the encrypted network key 212 to the authenticated remote device 108.

In this embodiment the control module 202 uses the pre-configured link key 214 (stored in memory 206) to encrypt the transfer of the closed network network key 212 to the remote device 108.

Alternatively the authentication server 112, in response to successfully authenticating the remote device 108, generates the message(s) to supply the parameters of the closed network 106 and the encrypted network key 212 to the authenticated remote device 108, and transmits the message(s) to the remote device 108 via the network coordinator 102. That is, the network coordinator 102 receives the message(s) from the authentication server 112 and relays them to the remote device 108 to supply the remote device with the parameters of the closed network 106 and the encrypted network key 212.

In this embodiment, the authentication server 112 has access to and uses the pre-configured link key 214 (e.g. stored in the server 112 or in data store 114) to encrypt the transfer of the closed network network key 212 to the remote device 108. It will be appreciated that in this embodiment, the authentication server 112 also has access to the parameters of the closed network 106 (e.g. stored in the server 112 or in data store 114)

For either of the above cases, for enhanced security it may be desirable to encrypt the details of the closed network (i.e. the parameters of the closed network 106 and the encrypted network key 212) from the point of origin (e.g. at the network coordinator 102 or the authentication server 112). As will be appreciated, this requires a further encryption key which is referred to herein as the “closed network details key” 216.

As shown in FIG. 2, the network coordinator 102 may store the closed network details key 216. In response to receipt of an authentication response indicating a successful authentication of the remote device 108, the control module 202 may be configured to use the closed network details key 216 to encrypt the transmission of a closed network details message (comprising the parameters of the closed network 106 and the encrypted network key 212) to the remote device 108.

Alternatively, the authentication server 112 may store the closed network details key 216 (e.g. stored in the server 112 or in data store 114). In response to receipt of a unique identifier of an authorised remote device 108, the authentication server 112 may be configured to use the closed network details key 216 to encrypt the transmission of a closed network details message (comprising the parameters of the closed network 106 and the encrypted network key 212) to the remote device 108 via the network coordinator 102.

It will be appreciated that the remote device 108 requires a copy of the closed network details key 216 stored in its non-volatile memory so that it can be used to decrypt the received closed network details message.

Whilst FIG. 3b shows the transmission of one or more parameters of the closed network 106 at step S312. In other embodiments, parameter(s) of the closed network 106 are not transmitted to the remote device.

The parameter(s) of the closed network 106 help the joining device identify the correct network before it attempts the join process. In most cases, it would be likely that the remote device 108 would find the closed network 106 first anyway. Even if it didn't, the remote device 108 is using a pre-configured link-key 214 to join so if it found another network first and attempted to join it, it would not be successful. It would then need to repeat the process until it found a different network—i.e. the closed network 106.

In embodiments where parameter(s) of the closed network 106 are transmitted to the remote device at step S312, it may be just the 64-bit PAN ID that is transmitted to the remote device 108, however it is more efficient to pass all parameters (e.g. the 64-bit PAN ID, 16-bit PAN ID, Extended Unique Identifier (EUI64) and operating frequency of the closed network 106).

FIG. 3c illustrates a third sequence diagram illustrating steps performed by the network coordinator 102 in the scenario of an unsuccessful authentication of the remote device 108.

The control module 202 of the network coordinator 102 receives, via the transceiver 204, the authentication response (indicating failed authentication of the remote device 108) transmitted by the authentication server 112 at step S308.

Following the unsuccessful authentication, the network coordinator 202 does not permit the remote device 108 access to the closed network 106 (the network coordinator 202 does not transmit details of the closed network 106 to the remote device 108).

Instead, the control module 202 transmits a reject message at step S320 to the remote device 108 via the transceiver 204. This causes the remote device 108 to leave the installation network 104.

In embodiments whereby the memory 206 stores the closed network blacklist 208b referred to above, at step S318 the control module 202 is configured to add the unique identifier of the remote device 108 received at step S304 to the closed network blacklist 208b (to prevent re-join attempts—described in more detail below).

It will be appreciated from the above that the operation of the network coordinator 102 advantageously isolates the closed network 106 from any non-authorised devices.

In embodiments whereby the memory 206 stores the closed network whitelist 208a referred to above the control module 202 is configured, in response to receiving the unique identifier of the remote device 108 at step S302, to query the closed network whitelist 208a to determine whether the received unique identifier has been previously stored by the control module 202 in the closed network whitelist 208a. If the received unique identifier has been previously stored in the closed network whitelist 208a, then the control module 202 is able to determine that the remote device 108 is authorised to access the closed network 106 without having to communicate with the authentication server (steps S304, S306 and S308 are not performed). Thus processing load on the control module 202, processing load on the authentication server 112, and network traffic between the network coordinator 102 and the authentication server 112 is advantageously reduced.

If the received unique identifier has not been previously stored in the closed network whitelist 208a, then the control module 202 is configured to communicate with the authentication server 112 as shown in FIG. 3a in order to determine whether the remote device 108 is authorised to access the closed network 106.

In addition to the closed network whitelist 208a, the memory 206 may store a closed network blacklist 208b that is referred to above.

In embodiments whereby the memory 206 stores both the closed network whitelist 208a and the closed network blacklist 208b, if the control module 202 determines that the unique identifier received at step S302 has not been previously stored in the closed network whitelist 208a, then the control module 202 is configured to query the closed network blacklist 208b to determine whether the unique identifier has been previously stored by the control module 202 in the closed network blacklist 208b.

If the received unique identifier has not been previously stored in the closed network blacklist 208b, then it is the first time that the remote device 108 has requested access to the closed network 106 and thus the control module 202 communicates with the authentication server as shown in FIG. 3a in order to determine whether to grant the remote device 108 access to the closed network 106 (steps S304, S306 and S308 are performed).

If the received unique identifier has been previously stored in the closed network blacklist 208b, then the control module 202 is able to determine that the remote device 108 is not authorised to access the closed network 106 without having to communicate with the authentication server (steps S304, S306 and S308 are not performed). Thus processing load on the control module 202, processing load on the authentication server 112, and network traffic between the network coordinator 102 and the authentication server 112 is advantageously reduced. In this scenario, the control module 202 transmits a reject message at step S320 to the remote device 108 via the transceiver 204 to cause the unauthorised remote device 108 to leave the installation network 104.

In embodiments, in a scenario whereby multiple network coordinator devices are installed at different locations. The respective installation networks can be used to allow authenticated devices to move between locations, temporarily joining different ZigBee networks within organisations which have logged their authentication details in the authentication server 112.

Embodiments of the present disclosure, also allow devices to be shared between different secure closed networks hosted by network coordinators at difference locations. For example an authorised remote device in a delivery vehicle may join a different closed network at each end of the journey. The open networks formed by the respective network coordinator devices would allow the join requests to be verified. This could be used, for example, to monitor the temperature or some other physical parameter of the transported goods (sensed by a sensor on the remote device) and pass the information directly to the supplier, customer and/or transport operator via the cloud 110.

Embodiments of the present disclosure, advantageously negate the risk of a remote device joining the wrong closed (e.g. ZigBee HA) network, in the worst-case the remote device could possibly join a neighbouring guest network that is also connected to the same cloud based authentication server which could then pass details of an alternative guest network and/or possibly encrypted details of target closed network.

Whilst embodiments have been described with reference to the installation network 104 and the closed network 106 being Zigbee networks, embodiments of the present disclosure extend to other network protocols if their security model permits it.

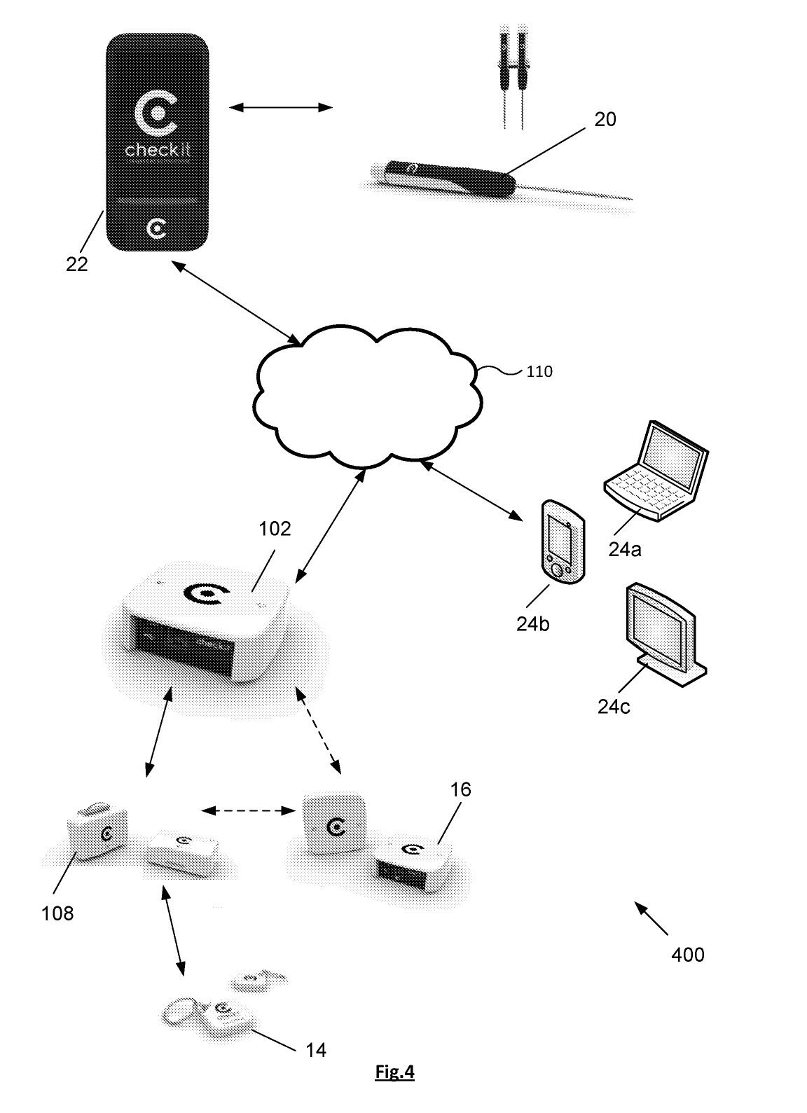

We turn now to FIG. 4, which illustrates an example architecture 400 comprising the communication system 100 of FIG. 1.

FIG. 4 illustrates an architecture 400 for performing checks and compiling reports using the communication system 100. The architecture 400 (also known as “Checkit”) comprises a plurality of modular system components which work together to provide fast and easy food safety monitoring and to simplify Hazard Analysis and Critical Control Point (HACCP) reports. The architecture 400 comprises one or more fixed sensors 108 (referred to above as remote devices), which are smart, wireless sensors installed in a particular environment to continuously monitor variables such as temperature, humidity, and door open/close status. The one or more fixed sensors 108 communicate with a hub device 102 (referred to above as a network coordinator), which receives the data collected by each fixed sensor 108 (once provided access to the closed network 106 hosted by the hub device 102 in accordance with embodiments described above).

In accordance with embodiments described above, each fixed sensor 108 may first join the installation network 104 hosted by the hub device 102 so that authentication can be carried out. The hub device 102 only permits each fixed sensor 108 access to the closed network 106 hosted by the hub device 102 if the fixed sensor 108 is successfully authenticated by the authentication server 112 in the cloud 110 (not shown in FIG. 4).

The one or more sensors 108 preferably transmit data to the hub device 102 via wireless means, since a single hub device 102 is positioned in an area containing multiple fixed sensors 108. The hub 102 is configured to collate all the data received from the or each fixed sensor 108. Preferably, the hub 102 also timestamps the data with the time it is received. The or each fixed sensors 108 collects and transmits fixed location environment data relating to the environment being monitored to the hub 102 either directly (as shown by the black arrow) if the fixed sensor is close enough to the hub 102 to communicate with it wirelessly, or indirectly via a repeater 16 (as shown by the dashed arrow), if the fixed sensor 108 is too far away from the hub 102 to communicate with it wirelessly. Each fixed sensor 108 automatically collects and transmits readings to the hub 102 every few minutes (optionally, via the repeater 16). This generates a continuous stream of data which may record, for example, whether or not a freezer is operating within the required optimum temperature range.

The hub 102 acts as the on-site gateway for the architecture 400, and is configured to receive and store the data from the or each authorised fixed sensor 108. The hub 102 may be any computing device such as a PC, laptop computer, tablet computer, etc., which is configured for this function, or alternatively, the hub 102 is a purpose-built device. For example, the hub 102 may be a flat panel touchscreen device that is a modular component of the architecture 400 and is designed to be used with the other modular components (e.g. the sensors). The hub 102 is configured to run web-based software that enables users to set up their own HACCP procedures. The graphic user interface of the software alerts users to any issues requiring their attention, such as, for instance, a refrigerator that is not working within the required temperature range. The hub 102 may be configurable to send alerts to a user's PC, tablet or smartphone as soon as data indicating a problem is received from a fixed sensor or handheld sensor. The hub 102 automatically stores and organises data received from the or each fixed sensor 108, to provide an accurate log of the user's food safety and hygiene processes. Data is also automatically transmitted from the hub 102 to the cloud 110 for secure storage and remote access.

The hub device 102 is preferably provided with the “Checkit” software pre-installed, such that it can be set-up and used easily. The software comprises the user interface to enable a user to set-up and use the system to monitor an environment, and includes drivers for any peripheral devices (such as the fixed sensor).

The architecture 400 further comprises at least one magnetic fob 14 which is used to install the or each fixed sensor 108 within the system. Sensor installation comprises registering the sensor within the system, naming the sensor (so that it can be readily identified by users and the system), and placing the sensor in the environment to be monitored.

Preferably, each fixed sensor 108 is uniquely identifiable to enable a user to distinguish between sensors when they are installing/using the sensors. Each fixed sensor 108 comprises a user-friendly alphanumeric identifier (UFID), which is appended to the sensor (e.g. printed on the sensor or via a label adhered to the sensor), to enable a user to readily identify the sensor visually. The UFID may be formed of characters from the sensor's MAC address.

To install each fixed sensor within the environment to be monitored, each sensor is temporarily placed in the environment to determine the strength of a signal transmitted by the sensor and received by the hub device 102, such that it may be repositioned if the signal strength is too weak. Each fixed sensor is then permanently attached in place within the monitored environment (e.g. using adhesive pads, glue, screws, etc.), so that the sensor always monitors the environment from the same, fixed position within the environment. The term “signal strength” may be based on link quality index (LQI), the received signal strength indicator (RSSI), or a combination of both metrics.

The Checkit software on the hub 102 provides an installation wizard to guide a user to install sensors in the monitored environment and within the architecture 400. The installation wizard prompts the user to collect all fixed sensors 108 to be installed. The software displays a list of sensors installed in the environment, which will be an empty list at the start of this process. The user is prompted to activate a sensor to be installed, by choosing a fixed sensor 108 and using the magnetic fob 14 to activate the sensor. Each fixed sensor 108 comprises a reed switch, which is operated by an applied magnetic field. The magnetic fob 14 is brought close to, or pressed against, the fixed sensor 108 to switch the sensor on. The sensor preferably comprises one or more lights or LEDs to visually indicate whether a sensor is operating correcting, which provides a more user-friendly component for a user to install and use.

The architecture 400 further comprises at least one handheld sensor 20. In embodiments, the handheld sensor is a smart, wireless temperature sensor. The handheld temperature sensor 20 enables users to perform checks and monitor storage and holding temperatures quickly. The handheld sensor 20 collects mobile location temperature data which is wirelessly transmitted to a portable computing device 22. The portable device 22 comprises a processor configured to receive the mobile location temperature data from the or each handheld sensor 20, and transmit an auditable version of the received mobile location environment data to the cloud for secure storage and remote access. The portable device 22 may be a smartphone, tablet, or other mobile computing device. In embodiments, the portable device 22 runs a mobile operating system such as the Android (RTM) operating system. The portable device 22 advantageously comprises the functionality and capability of a smartphone, such as the ability to capture images of barcodes and read barcodes, and to communicate with peripheral devices using Bluetooth, NFC, Zigbee etc.

The portable device 22 is used to display workflow task lists to a user, to prompt a user to perform particular tasks. The portable device is also used to store the results of the tasks (e.g. any collected data, and/or an indication of when a task was completed), and to transmit the stored results to the cloud. Preferably, the portable device retains the results in its local memory until receipt of the data by the cloud server is confirmed. This ensures that data is not deleted until it has been safely stored in the central, cloud-based data store.

While the architecture 400 is primarily described as a means to monitor temperature within a monitored environment, the architecture 400 is not limited to this purpose. The fixed and mobile sensors may be temperature sensors, humidity sensors, door contact sensors, and any other sensor which can be used to monitor conditions with an environment and/or the operation of components within an environment (e.g. refrigerators, freezers, ovens, cookers, etc.).

The architecture 400 further comprises one or more computing device, such as a laptop 24a, a portable device 24b (such as a tablet, or smartphone), or a PC 24c. The computing device provides a web client (e.g. a web browser) which enables a user to access the data stored within the hub device 102 and/or the data stored within the cloud 110. If the computing device is located within the monitored environment, it may access the hub device 102 via the intranet, whereas a secure connection may be used to enable the web client to access the cloud (e.g. via SSL).

The mobile location environment data received by the portable device 22 from the or each handheld sensor 20 is time stamped on receipt, and may further be appended with information to indicate the provenance of the data. For example, the processor of the portable device 22 is configured to timestamp the received data and to add information indicating that the data was received by that particular portable device. In embodiments, each handheld sensor 20 has the capability to append provenance data to the measured mobile location environment data, to indicate the data was measured by a particular handheld sensor. This provenance information is used to identify how the measured mobile location environment data is transmitted from the sensor to the cloud. The provenance information also enables the authenticity of the data to be verified.

Advantageously, data is kept on the devices that generate the data until the data has been stored in the cloud. Furthermore, the provenance information enables the authenticity of data to be checked, which minimises the risk of data being tampered with. Another advantage is that functionalities of the architecture can be provided through software in the cloud. This means that if the internet connection at a particular site fails temporarily, a simpler service can be run locally at the site.

Whilst FIG. 4 illustrates an example application of embodiments of the present invention, it will be appreciated that embodiments of the present invention are not limited to this example application and may be used in other contexts.

While this invention has been particularly shown and described with reference to preferred embodiments, it will be understood to those skilled in the art that various changes in form and detail may be made without departing from the scope of the invention as defined by the appendant claims.

1-24. (canceled)

25. A device for permitting a remote device access to a secure network, the device comprising:
a wireless transceiver;
a memory storing a network key associated with the secure network; and
a control module, wherein the control module is configured to:
form a first network and form the secure network;
allow the remote device to join the first network upon detection of the remote device having a network key associated with the first network, wherein the network key associated with the first network is also stored in said memory;
and once the remote device has joined the first network, the control module is configured to:
receive, via said wireless transceiver, a unique identifier of the remote device transmitted from the remote device;
determine whether the remote device is authorised to access the secure network based on said unique identifier; and
transmit, via said wireless transceiver, the network key associated with the secure network in encrypted form to the remote device to permit the remote device access to the secure network, in dependence on said determination.

26. The device of claim 25, wherein the control module is configured to:
transmit, via said wireless transceiver, the unique identifier to an authentication server;
receive, via said wireless transceiver, an authentication response from the authentication server; and
determine whether the remote device is authorised to access the secure network based on said authentication response.

27. The device of claim 25, wherein the memory comprises a whitelist which is arranged to store unique identifiers of remote devices successfully authenticated by an authentication server, and the control module is configured to query the whitelist and determine that said remote device is authorised to access the secure network based on the unique identifier being present in the whitelist.

28. The device of claim 27, wherein the control module is further configured, in response to determining that the unique identifier is not present in the whitelist, to transmit, via said wireless transceiver, the unique identifier to the authentication server;
receive, via said wireless transceiver, an authentication response from the authentication server; and
determine whether the remote device is authorised to access the secure network based on said authentication response.

29. The device of claim 27, wherein the memory comprises a blacklist which is arranged to store unique identifiers of remote devices that have failed authentication by the authentication server, and the control module is further configured, in response to determining that the unique identifier is not present in the whitelist, to query the blacklist and determine that said remote device is not authorised to access the secure network based on the unique identifier being present in the blacklist, and optionally
the control module is further configured, in response to determining that the unique identifier is not present in the blacklist, to
transmit, via said wireless transceiver, the unique identifier to the authentication server;
receive, via said wireless transceiver, an authentication response from the authentication server; and
determine whether the remote device is authorised to access the secure network based on said authentication response.

30. The device of claim 28, wherein the control module is configured, in response to determining that the remote device is authorised to access the secure network, to add the unique identifier to the whitelist.

31. The device of claim 30, wherein the control module is configured, in response to determining that the remote device is not authorised to access the secure network, to add the unique identifier to the blacklist.

32. The device of claim 25, wherein the control module is configured, in response to determining that the remote device is authorised to access the secure network, to transmit the network key associated with the secure network in encrypted form, to the remote device, and optionally
the control module is further configured, in response to determining that the remote device is authorised to access the secure network, to transmit at least one parameter of the secure network to the remote device, and optionally
the at least one parameter comprising one or any combination of: an Extended Personal Area Network Identifier associated with the secure network, a Personal Area Network Identifier associated with the secure network, a 64-bit Extended Unique Identifier associated with the secure network, and an operating frequency of the secure network.

33. The device of claim 32, wherein the memory stores an encryption key for encrypting the network key associated with the secure network, and the control module is configured to use said encryption key to encrypt the network key associated with the secure network, and optionally
wherein the memory stores a further encryption key and the control module is configured to generate a message comprising at least the encrypted network key associated with the secure network, and transmit the message in encrypted form to the remote device using the further encryption key.

34. The device of claim 25, wherein the control module is configured, in response to determining that the remote device is not authorised to access the secure network, to transmit a reject message to the remote device to cause the remote device to leave the first network.

35. The device of claim 25, wherein the unique identifier comprises a serial number associated with the remote device or a medium access control address associated with the remote device.

36. The device of claim 25, wherein the unique identifier comprises a hash value derived from a hash function computed at the remote device.

37. The device of claim 25, wherein the control module is configured to receive via the transceiver, a request to join the first network transmitted from the remote device, and in response, transmit via the transceiver the network key associated with the first network in unencrypted form to the remote device.

38. The device of claim 25, wherein the control module is configured to form the first network as a secure network, whereby only remote devices pre-programmed with the network key associated with the first network are permitted to join the first network.

39. The device of claim 25, wherein the control module is configured to form the first network using a preconfigured Extended Personal Area Network Identifier or an Extended Personal Area Network Identifier selected from a preconfigured range of values for the Extended Personal Area Network Identifier.

40. The device of claim 25, wherein the control module is configured to receive, via the transceiver, a request to join the secure network that is transmitted by the remote device over the first network, and allow the remote device to join the secure network upon detection of the remote device having the network key associated with the secure network.

41. The device of claim 25, wherein the first network and the secure network are Zigbee networks.

42. A method for permitting a remote device access to a secure network, the method comprising:
forming a first network and forming the secure network;
allowing the remote device to join the first network upon detection of the remote device having a network key associated with the first network;
and once the remote device has joined the first network, the method further comprising:
receiving a unique identifier of the remote device transmitted from the remote device;
determining whether the remote device is authorised to access the secure network based on said unique identifier; and
transmitting, via said wireless transceiver, the network key associated with the secure network in encrypted form to the remote device to permit the remote device access to the secure network, in dependence on said determination.

43. A computer program product for permitting a remote device access to a secure network, the computer program product comprising code embodied on a computer-readable medium and being configured so as when executed on a processor to:
form a first network and form the secure network;
allow the remote device to join the first network upon detection of the remote device having a network key associated with the first network;
and once the remote device has joined the first network, the code being further configured so as when executed on the processor to:
receive a unique identifier of the remote device transmitted from the remote device;
determine whether the remote device is authorised to access the secure network based on said unique identifier; and
transmit the network key associated with the secure network in encrypted form to the remote device to permit the remote device access to the secure network, in dependence on said determination.

44. A communication system comprising:
the device of claim 25;
a cloud-based authentication server connected to said device; and
at least one remote device.
